(19) United States
(12) Patent Application Publication
(10) Pub. No.: US 2016/0275255 A1
(43) Pub. Date: Sep. 22, 2016

(54) ANIMAL HEALTHCARE DEVICE AND HEALTHCARE METHOD USING SAME

(71) Applicant: PNV Co., Ltd., Seoul (KR)

(72) Inventors: Hoonsup Shim, Seoul (KR); Daah Kim, Seoul (KR)

(21) Appl. No.: 15/073,893

(22) Filed: Mar. 18, 2016

(30) Foreign Application Priority Data
Mar. 19, 2015 (KR) 10-2015-0038410

(51) Int. Cl. G06F 19/00

(52) U.S. Cl. CPC G06F 19/345; G06F 19/322

(57) ABSTRACT

The present invention relates to an animal healthcare device which includes an input unit configured to receive questionnaire items according to a prevalent disease for each classified animal group and diagnostic information of the animal using a differential diagnosis or examination content corresponding to the questionnaire items; a determination unit configured to determine whether the prevalent disease is expressed using the diagnostic information; and an output unit configured to output whether the prevalent disease is expressed.

### CROSS-REFERENCE TO RELATED APPLICATION

This application claims priority to and the benefit of Korean Patent Application No. 10-2015-0038410 filed on Mar. 19, 2015, the disclosure of which is incorporated herein by reference in its entirety.

### FIELD OF INVENTION

An embodiment according to a concept of the present invention relates to animal healthcare, and specifically, to a technology for providing an individual animal-customized healthcare program using characteristics, biometric information and medical information of an individual animal.

### BACKGROUND

Recently, interest in pets has increased, and the status of pets has been changing from pets to companion animals similar to family members.

With the increase in households raising companion animals, offline service markets for caring for companion animals such as animal hospitals, companion animal beauty salons, and dog cafes are continuously growing. It is possible to find online websites, blogs, cafes and the like related to companion animal sales, companion animal product sales, hygiene care such as vaccination of companion animals, and grooming of companion animals.

Meanwhile, caregivers of companion animals make efforts to prevent various diseases such as vaccination, scaling, anthelmintic administration, and regular examinations in view of disease prevention of companion animals, and provide healthcare of companion animals depending on “companion notebooks” and the like provided from animal hospitals.

However, caregivers of companion animals have a problem in that they need to directly plan and receive services related to companion animal healthcare provided from the above various online/offline services.

Also, in order to perform companion animal healthcare more accurately and easily, a consensus on medical care according to characteristics of a breed, an age, and a sex of companion animals and differentiated healthcare needs is formed early. However, it was very difficult to immediately identify and apply individual characteristics of a plurality of breeds of pet dogs in the medical field.

### SUMMARY OF THE INVENTION

The present invention has been made in view of the above problems, and the technological object of the present invention is to provide a device configured to provide a disease diagnosis result of a diagnosis target animal and a target animal-customized healthcare program using diagnostic information of diseases that frequently occur for each group classified by breeds and age ranges of animals, and a healthcare method using the device.

The present invention also provides a device and method through which the diagnostic information, a performance result of the healthcare program, and biometric information detected by a wearable device worn by the target animal are used to provide the disease diagnosis result and a disease examination result to a caregiver and a medical system of an animal hospital.

The present invention also provides a device and method through which biometric information of disease-expressing animals is classified into groups classified by breeds and age ranges of animals, and the classified biometric information for each group is used to determine whether a disease is expressed in an examination target animal.

An animal healthcare device according to an embodiment of the present invention may include an input unit configured to receive questionnaire items according to a prevalent disease for each classified animal group and diagnostic information of an animal using a differential diagnosis or examination content corresponding to the questionnaire items; a determination unit configured to determine whether the prevalent disease is expressed using the diagnostic information; and an output unit configured to output whether the prevalent disease is expressed.

According to an embodiment, the input unit may further receive an examination result of a health examination program determined according to the disease, and the determination unit may determine whether the disease is expressed using the diagnostic information and the examination result.

According to an embodiment, the animal healthcare device may further include a transmission unit configured to transmit a health examination program determined according to the disease to a caregiver terminal of the animal.

According to an embodiment, the classified animal group may be a group classified by breeds and age ranges of animals, and the questionnaire items may be questionnaire items related to a disease that occurs at a frequency above a reference frequency for each group.

According to an embodiment, the prevalent disease may include at least one of a cardiac disease, an oral disease, a skin disease, an endocrinological/metabolic disease, a gastrointestinal disease, a blood disease, a musculoskeletal disease, a tumor, a neurological disease, an ophthalmic disease, a respiratory disease, a genitourinary disease, and a drug-susceptible disease.

An animal healthcare device according to another embodiment of the present invention may include an input unit configured to receive questionnaire items according to a prevalent disease for each classified animal group and an examination result of a health examination program determined according to a prevalent disease for each group; a reception unit configured to receive biosignal information of an animal; a determination unit configured to compare the biosignal information of the animal with biosignal information for each group, and determine whether a disease corresponding to the biosignal information for each group is expressed using the comparison result; and an output unit configured to output the determination result of whether the disease is expressed, in which the biosignal information for each group may be biosignal information obtained such that, when it is determined whether the prevalent disease is expressed, the biosignal information of the animal is classified into a normal group or a disease-specific group according to a determination result of whether the prevalent disease is expressed using diagnostic information according to the questionnaire items and the examination result.

According to an embodiment, the animal healthcare device may further include a transmission unit configured to transmit disease information determined using the comparison result to a caregiver terminal of the animal and transmit the disease information and the examination result to an electronic medical record (EMR) system of an animal hospital in which the animal is registered.

According to an embodiment, the biosignal information may be a biosignal that includes at least one of a heart rate, a respiration rate, an amount of exercise, and a body temperature of the animal.

According to an embodiment, the determination unit may compare a pattern of average data of the received biosignal information of the animal with a pattern of average data of biosignal information for each group, and determine whether a disease corresponding to the biosignal information for each group is expressed using the comparison result.

According to an embodiment, the determination unit may determine a degree of similarity between the pattern of average data of the received biosignal information of the animal and the pattern of average data of biosignal information for each group, and determine whether a disease corresponding to the biosignal information for each group is expressed according to the determination result.

According to an embodiment, the average data of biosignal information for each group includes at least one of an average value, a median value, a standard deviation, and a change rate of biosignal information for each classified group.

According to an embodiment, the pattern of average data of biosignal information for each group may be a pattern of average data corresponding to the disease-specific group when a ratio between average data corresponding to the normal group and the average data corresponding to the disease-specific group is outside of a predetermined ratio.

An animal healthcare method according to still another embodiment of the present invention may include receiving questionnaire items according to a prevalent disease for each classified animal group; receiving diagnostic information of an animal using a differential diagnosis or examination content corresponding to the questionnaire items; and determining whether a disease is expressed in the animal using the diagnostic information.

According to an embodiment, the animal healthcare method may further include receiving an examination result of a health examination program determined according to the disease, in which, in the determining, it is determined whether the disease is expressed using the diagnostic information and the examination result.

According to an embodiment, the animal healthcare method may further include transmitting a health examination program determined according to the disease to a caregiver terminal of the animal.

According to an embodiment, the classified animal group may be a group obtained by classifying animals by breeds and age ranges, and the questionnaire items may be questionnaire items related to a disease that occurs at a frequency above a reference frequency for each group. The prevalent disease may include at least one of a cardiac disease, an oral disease, a skin disease, an endocrinological/metabolic disease, a gastrointestinal disease, a blood disease, a musculoskeletal disease, a tumor, a neurological disease, an ophthalmic disease, a respiratory disease, a genitourinary disease, and a drug-susceptible disease.

According to an embodiment, the animal healthcare method may further include classifying determined biosignal information of the animal into a normal group or a disease-specific group according to a determination result of whether the disease is expressed; receiving daily biosignal information of the animal; and comparing the daily biosignal information with biosignal information for each group, and determining whether a disease corresponding to the biosignal information for each group is expressed using the comparison result.

According to an embodiment, the animal healthcare method may further include transmitting disease information determined using the comparison result to a caregiver terminal of the animal, and transmitting the disease information and the examination result to an electronic medical record (EMR) system of an animal hospital in which the animal is registered.

According to an embodiment, in the comparing of the daily biosignal information with the biosignal information for each group and the determining of whether a disease corresponding to the biosignal information for each group is expressed using the comparison result, a pattern of average data of the daily biosignal information of the animal may be compared with a pattern of average data of the biosignal information for each group, a degree of similarity between the two patterns may be determined, and it may be determined whether a disease corresponding to the biosignal information for each group is expressed according to the determination result.

According to an embodiment, the comparing of the daily biosignal information with the biosignal information for each group may include: calculating average data including an average value, a median value, a standard deviation, and a change rate of the biosignal information for each classified group; and comparing at least one of average data calculated as above with the average data of the daily biosignal information of the animal. The pattern of average data of biosignal information for each group may be a pattern of average data corresponding to the disease-specific group when a ratio between average data corresponding to the normal group and the average data corresponding to the disease-specific group is outside of a predetermined ratio.

### BRIEF DESCRIPTION OF THE DRAWINGS

In order to further sufficiently understand the drawings described in a detailed description of the present invention, detailed descriptions of the drawings will be provided.

FIG. 1 is a diagram illustrating a concept of an animal healthcare service using an animal healthcare device according to an embodiment to which a technology disclosed herein can be applied.

FIG. 2 is a block diagram illustrating an animal healthcare device according to an embodiment to which a technology disclosed herein can be applied.

FIG. 3 is a diagram illustrating an exemplary healthcare program prepared according to prevalent disease information for each animal group and each age range.

FIG. 4 is a diagram illustrating an exemplary protocol screen of an electronic medical record (EMR) system of an animal hospital.

FIG. 5 is a flowchart describing an animal healthcare method using an animal healthcare device according to an embodiment to which a technology disclosed herein can be applied.

### DETAILED DESCRIPTION

Specific structural or functional descriptions of embodiments according to a concept of the present invention disclosed herein are exemplified only to describe the embodiments according to a concept of the present invention. The embodiments according to a concept of the present invention can be performed in various forms and are not limited to embodiments described herein.

While the embodiments according to a concept of the present invention can be modified in various ways and take on several forms, embodiments are shown in the drawings and described in detail herein. However, the embodiments according to a concept of the present invention are not limited to the specific disclosed forms, but include all modifications, equivalents or alternatives falling within the spirit and scope of the present invention.

It will be understood that, although the terms “first,” “second,” etc. may be used herein to describe various elements, these elements will not be limited by these terms. These terms are only used to distinguish one element from another. For example, a first element could be termed a second element, and, similarly, a second element could be termed a first element, without departing from the scope of the present invention.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements will be interpreted in a like fashion (i.e., “between” versus “directly between,” “adjacent” versus “directly adjacent,” etc.).

It will be understood that the technical terminology used herein is for the purpose of describing particular embodiments only and is not intended to be limiting of the invention. Elements of the invention referred to in singular may number one or more, unless the context clearly indicates otherwise. It will be further understood that the terms “comprise,” “comprising,” “include,” and/or “including,” when used herein, specify the presence of stated features, numbers, steps, operations, elements, components, and/or groups thereof, but do not preclude the presence or addition of one or more other features, numbers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, will be interpreted as having a meaning that is consistent with their meaning in the context of the relevant art and will not be interpreted in an idealized or overly formal sense unless expressly so defined herein.

A suffix “module” or “unit” of an element used herein is assigned or incorporated for convenience of specification description, and the suffix itself does not have a distinguished meaning or function and may refer to hardware for implementing a method according to an embodiment of the present invention, software that can execute the hardware, or a functional or structural combination thereof.

Exemplary embodiments of the present invention, that is, an animal healthcare device and a healthcare method using the same, will be described below in detail with reference to the accompanying drawings.

A technology disclosed herein is applied to an animal healthcare device and a healthcare method using the same. However, the technology disclosed herein is not limited thereto, and can be applied to all animal healthcare devices and animal healthcare methods using a device to which a technological scope of the technology can be applied.

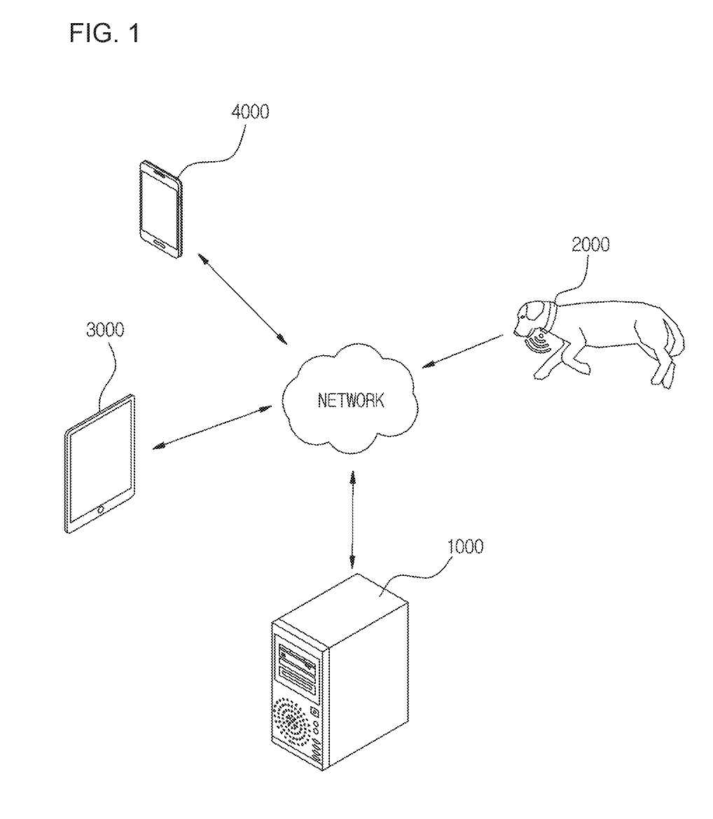

FIG. 1 is a diagram illustrating a concept of an animal healthcare service using an animal healthcare device according to an embodiment to which a technology disclosed herein can be applied.

As illustrated in FIG. 1, the animal healthcare service can be provided in a system that includes an animal healthcare device 1000 according to the embodiment of the present invention, a sensing device 2000 worn by an animal, an electronic medical record (EMR) system 3000 used in an animal hospital, and a caregiver terminal 4000.

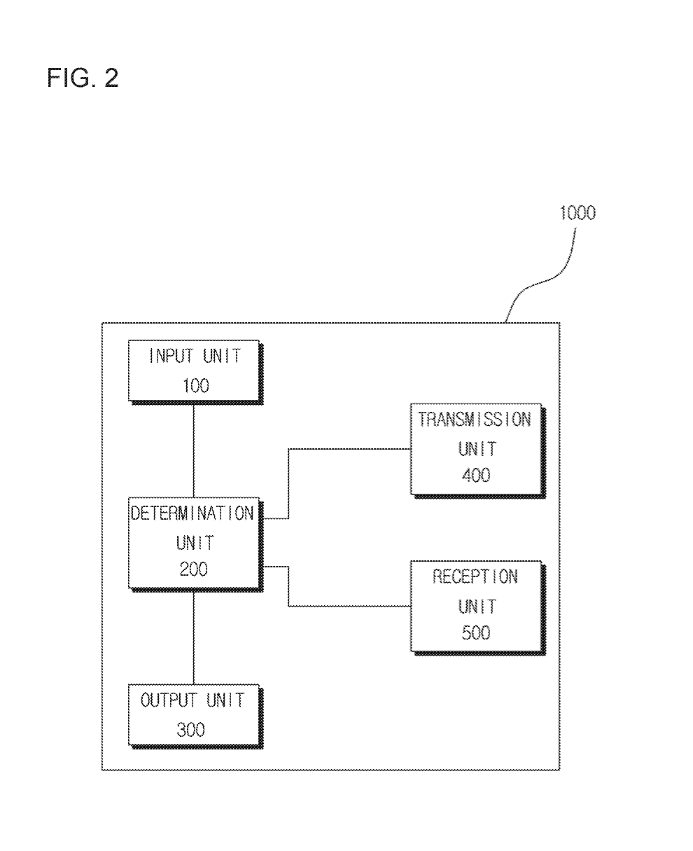

FIG. 2 is a block diagram illustrating an animal healthcare device according to an embodiment to which a technology disclosed herein can be applied.

As illustrated in FIG. 2, the animal healthcare device 1000 according to the embodiment of the present invention may include an input unit 100 configured to receive answers of an animal caregiver to questionnaire items for diagnosing a disease that occurs at a frequency above a reference frequency for each classified animal group, that is, a prevalent disease, and receive diagnostic information of the animal using a differential diagnosis and examination content corresponding to the questionnaire items, a determination unit 200 configured to determine whether the prevalent disease is expressed using the diagnostic information, an output unit 300 configured to output whether the prevalent disease is expressed, and a transmission unit 400 configured to transmit a health examination program determined according to the disease to the caregiver terminal 4000 of the animal.

The determination unit 200 may determine whether the prevalent disease is expressed using the diagnostic information, prepare and output a health examination program according to the determination result, or transmit the result to the caregiver terminal 4000.

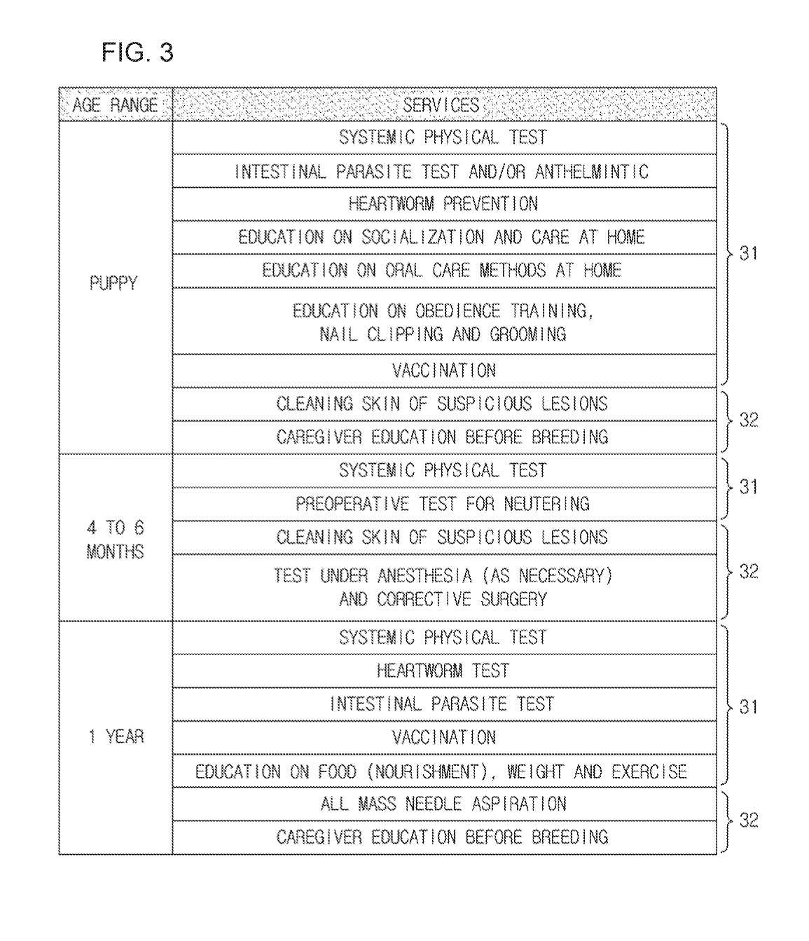

FIG. 3 is a diagram illustrating an exemplary healthcare program prepared according to prevalent disease information for each animal group and each age range.

As illustrated in FIG. 3, the healthcare program includes prevalent disease information and healthcare information 32 for each classified animal group, and disease information and healthcare information 31 related to services to be generally performed regardless of the prevalent disease information for each group.

The prevalent disease information for each group may be information on a disease that occurs at a frequency above a reference frequency in a specific breed and age range of the animal.

The input unit 100 may receive answers to the questionnaire items and receive examination results according to the health examination program performed by the caregiver.

Also, the determination unit 200 may determine whether a disease is expressed using diagnostic information according to the differential diagnosis and diagnostic examination content for determining a disease corresponding to the questionnaire items, and examination results according to the health examination program.

The transmission unit 400 may transmit the health examination program determined according to the disease to the caregiver terminal 4000 of the animal.

The classified animal groups may be grouped such that, first, animals are classified by breeds, and then the classified breeds are classified by age ranges. For example, when classification target animals are companion dogs, the companion dogs may be classified by breeds such as Chihuahua, Pug, and Boston Terrier. Then, the companion dogs of the same breed may be classified according to age ranges of six steps including puppy (birth to 4 months), 4 to 6 months, juvenile (1 year), adults (2 to 6 years), aging (7 to 9 years), and elderly (10 years or more). Therefore, when there are 60 types of breeds, companion dogs may be classified according to age ranges of six steps for each of 60 breeds, and then the 360 groups may be provided. Questionnaire items for diagnosing a prevalent disease may be matched for each group.

The questionnaire items may be a set of questionnaire items related to a disease that occurs at a frequency above a reference frequency for each group of the companion dogs.

The prevalent disease may include at least one of 13 prevalent diseases including a cardiac disease, an oral disease, a skin disease, an endocrinological/metabolic disease, a gastrointestinal disease, a blood disease, a musculoskeletal disease, a tumor, a neurological disease, an ophthalmic disease, a respiratory disease, a genitourinary disease, and a drug-susceptible disease.

Also, the animal healthcare device 1000 according to the embodiment of the present invention may further include a reception unit 500 configured to receive biosignal information of the animal.

In this case, the determination unit 200 may receive questionnaire items according to a prevalent disease for each classified animal group, and examination results of the health examination program determined according to the prevalent disease for each group, determine whether the prevalent disease is expressed using diagnostic information according to the questionnaire items and the examination results, classify biosignal information of determination target animals into a normal group or a disease-specific group according to the determination result while determining whether the prevalent disease is expressed, and store the result in a storage unit (not illustrated).

Then, the determination unit 200 may compare biosignal information of the animal's daily life received by the reception unit 500 with biosignal information classified for each group, and determine whether a disease corresponding to the biosignal information classified for each group is expressed using the comparison result.

In this case, the transmission unit 400 may transmit disease information determined using the comparison result of the biosignal information to the caregiver terminal 4000 of the animal, and also transmit the determined disease information and the examination results according to the health examination program to the EMR system 3000 of an animal hospital in which the animal is registered.

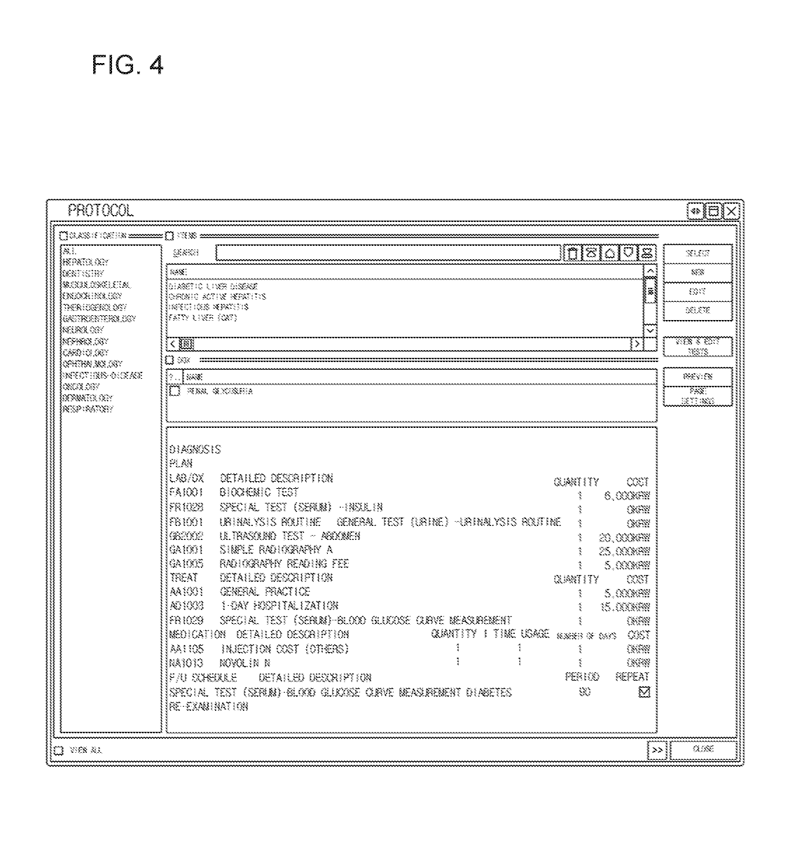

FIG. 4 is a diagram illustrating an exemplary protocol screen of an EMR system of an animal hospital. As illustrated in FIG. 4, the EMR system may display information related to diagnosis of a disease using data transmitted from the transmission unit 400 on the protocol screen of the EMR system.

Therefore, a veterinarian of an animal hospital may use the transmitted data as a reference material for caring for the animal, and provide accurate health diagnosis.

The biosignal information is a biosignal that includes at least one of a heart rate, a respiration rate, an amount of exercise, and a body temperature of the animal. The biosignal may be collected using the sensing device (a wearable device) 2000 worn by the animal.

Meanwhile, the determination unit 200 may obtain a pattern of average data of animal biosignal information received by the reception unit 500 and a pattern of average data of biosignal information for each group, and determine whether a disease corresponding to the biosignal information for each group is expressed using a comparison result of the two obtained patterns.

Whether the prevalent disease is expressed may be determined according to a degree of similarity of the two patterns. When the degree of similarity is in a range of predetermined values, it may be determined that the disease is expressed.

When it is determined that the pattern of average data of the received biosignal information of the animal is similar to a pattern of average data of biosignal information of an animal in a normal state, it may be determined that the animal of which the biosignal is detected is in a normal state.

Here, the average data of the biosignal information for each group includes at least one of an average value, a median value, a standard deviation, and a change rate of biosignal information for each classified group.

Also, when a value of a ratio between average data corresponding to the normal group and average data corresponding to the disease-specific group within the calculated average data is outside of a specific value range, the determination unit 200 may use a pattern of average data corresponding to the disease-specific group as an average data pattern of abnormal biosignal information of the disease-specific group.

When the veterinarian decides a disease of the animal based on the determined disease information and the examination results transmitted from the transmission unit 400 and inputs treatment/surgery, administration, and management plans to the EMR system according to the decision result, the reception unit 500 of the animal healthcare device 1000 may receive input content of the veterinarian, and the transmission unit 400 of the animal healthcare device 1000 may transmit an administration and visit instruction notification to the caregiver terminal 4000 based on an input prescription and instruction.

Also, the input unit 100 may receive administration according to the prescription and instruction of the veterinarian and process content of the instruction.

Also, the determination unit 200 may determine an amount of sleep, an amount of exercise and a stress index based on the biosignal of the examination target animal, and decide a recovery state of the examination target animal according to the determination result.

Here, the amount of sleep, the amount of exercise and the stress index may be determined in comparison with an average of an amount of sleep, an amount of exercise and a stress index of animal subjects of a group to which the examination target animal belongs.

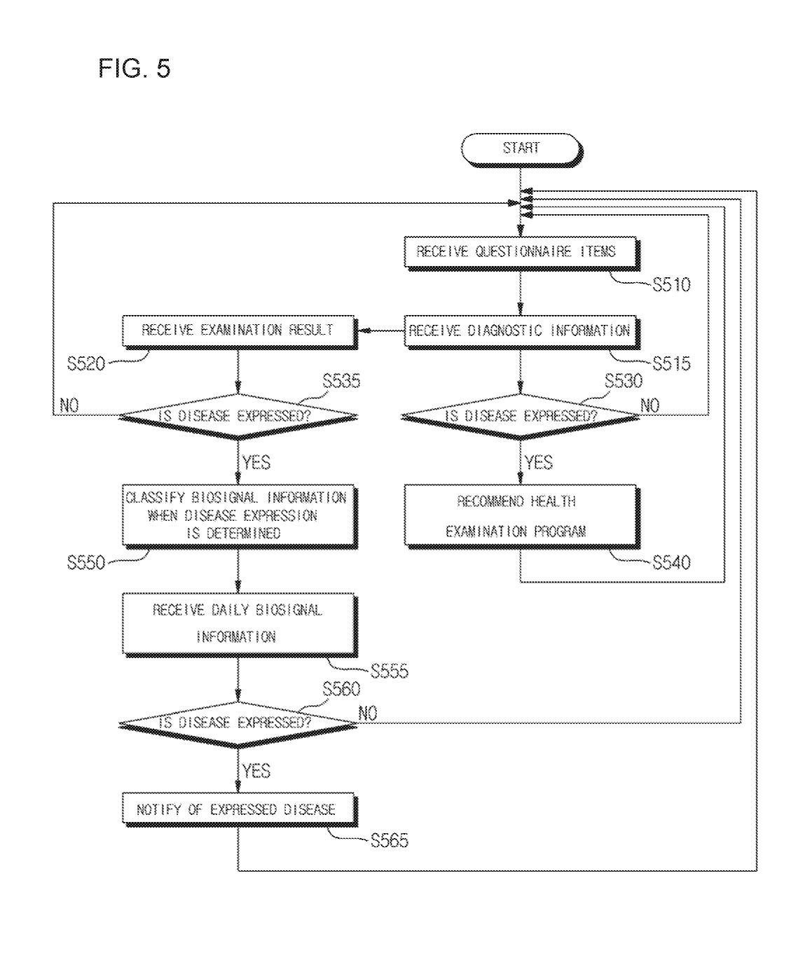

An animal healthcare method using the animal healthcare device 1000 according to the embodiment of the present invention will be described below with reference to FIG. 5.

FIG. 5 is a flowchart describing an animal healthcare method using an animal healthcare device according to an embodiment to which a technology disclosed herein can be applied.

As illustrated in FIG. 5, first, the input unit 100 receives questionnaire items according to a prevalent disease for each animal group classified by breeds and age ranges (S510). Also, the input unit 100 receives diagnostic information of the animal using a differential diagnosis content corresponding to the questionnaire items (S515).

Next, the determination unit 200 may determine whether a disease is expressed in the animal using the diagnostic information (S530). Here, when the input unit 100 further receives examination results according to a health examination program determined by a disease (S520), the determination unit 200 may determine whether a disease is expressed in the animal using the diagnostic information and the examination results (S535).

When it is determined, by the determination unit 200, whether a disease is expressed in the animal using the diagnostic information (S530), the animal healthcare device 1000 may transmit a health examination program determined according to the disease to a caregiver terminal of the animal (S540).

When it is determined, by the determination unit 200, whether a disease is expressed in the animal using the diagnostic information and the examination result (S535), determined biosignal information of the animal may be classified into a normal group or a disease-specific group according to the determination result of whether the disease is expressed (S550).

Then, the reception unit 500 receives daily biosignal information of the animal (S555). The determination unit 200 may compare the daily biosignal information with biosignal information for each group, and determine whether a disease corresponding to the biosignal information for each group is expressed using the comparison result (S560).

Next, the transmission unit 400 may transmit the disease information determined using the comparison result to the caregiver terminal of the animal, and transmit the disease information and the examination result to an EMR system of an animal hospital in which the animal is registered (S565).

According to the invention disclosed herein, it is possible to provide a disease diagnosis result of a diagnosis target animal and a target animal-customized healthcare program using diagnostic information of a disease that occurs at a frequency above a reference frequency for each group classified by breeds and age ranges of animals.

Also, it is possible to provide a disease diagnosis result and a disease examination result to a caregiver and a medical system of an animal hospital using diagnostic information of a disease that occurs at a frequency above a reference frequency for each group classified by breeds and age ranges of animals, a performance result of a healthcare program provided for each group, and biometric information detected by a wearable device worn by the target animal.

Also, it is possible to classify biometric information of disease-expressing animals into groups classified by breeds and age ranges of animals, and determine whether a disease is expressed in an examination target animal using the classified biometric information for each group.

While the present invention has been described with reference to the embodiments illustrated in the drawings, these are only examples. It will be understood by those skilled in the art that various modifications and other equivalent embodiments can be made from the invention. Therefore, the scope of the present invention is defined by the appended claims.

### REFERENCE NUMERALS

100 input unit
200 determination unit
300 output unit
400 transmission unit
500 reception unit
1000 animal healthcare device
2000 wearable sensing device
3000 animal hospital electronic medical record system
4000 caregiver terminal

What is claimed is:

1. An animal healthcare device comprising:
an input unit configured to receive questionnaire items according to a prevalent disease for each classified animal group and diagnostic information of an animal using a differential diagnosis or examination content corresponding to the questionnaire items;
a determination unit configured to determine whether the prevalent disease is expressed using the diagnostic information; and
an output unit configured to output whether the prevalent disease is expressed.

2. The animal healthcare device of claim 1,
wherein the input unit further receives an examination result of a health examination program determined according to the disease, and
wherein the determination unit determines whether the disease is expressed using the diagnostic information and the examination result.

3. The animal healthcare device of claim 1, further comprising a transmission unit configured to transmit a health examination program determined according to the disease to a caregiver terminal of the animal.

4. The animal healthcare device of claim 1,
wherein the classified animal group is a group classified by breeds and age ranges of animals, and
wherein the questionnaire items are questionnaire items related to a disease that occurs at a frequency above a reference frequency for each group.

5. The animal healthcare device of claim 4,
wherein the prevalent disease includes at least one of a cardiac disease, an oral disease, a skin disease, an endocrinological or metabolic disease, a gastrointestinal disease, a blood disease, a musculoskeletal disease, a tumor, a neurological disease, an ophthalmic disease, a respiratory disease, a genitourinary disease, and a drug-susceptible disease.

6. An animal healthcare device comprising:
an input unit configured to receive questionnaire items according to a prevalent disease for each classified animal group and an examination result of a health examination program determined according to a prevalent disease for each group;
a reception unit configured to receive biosignal information of an animal;
a determination unit configured to compare the biosignal information of the animal with biosignal information for each group, and determine whether a disease corresponding to the biosignal information for each group is expressed using the comparison result; and
an output unit configured to output the determination result of whether the disease is expressed,
wherein the biosignal information for each group is biosignal information obtained such that, when it is determined whether the prevalent disease is expressed, the biosignal information of the animal is classified into a normal group or a disease-specific group according to a determination result of whether the prevalent disease is expressed using diagnostic information according to the questionnaire items and the examination result.

7. The animal healthcare device of claim 6, further comprising:
a transmission unit configured to transmit disease information determined using the comparison result to a caregiver terminal of the animal and transmit the disease information and the examination result to an electronic medical record (EMR) system of an animal hospital in which the animal is registered.

8. The animal healthcare device of claim 6,
wherein the biosignal information is a biosignal that includes at least one of a heart rate, a respiration rate, an amount of exercise, and a body temperature of the animal.

9. The animal healthcare device of claim 6,
wherein the determination unit compares a pattern of average data of the received biosignal information of the animal with a pattern of average data of biosignal information for each group, and determines whether a disease corresponding to the biosignal information for each group is expressed using the comparison result.

10. The animal healthcare device of claim 9,
wherein the determination unit determines a degree of similarity between the pattern of average data of the received biosignal information of the animal and the pattern of average data of biosignal information for each group, and determines whether a disease corresponding to the biosignal information for each group is expressed according to the determination result.

11. The animal healthcare device of claim 10,
wherein the average data of biosignal information for each group includes at least one of an average value, a median value, a standard deviation, and a change rate of biosignal information for each classified group.

12. The animal healthcare device of claim 11,
wherein the pattern of average data of biosignal information for each group is a pattern of average data corresponding to the disease-specific group when a ratio between average data corresponding to the normal group and the average data corresponding to the disease-specific group is outside of a predetermined ratio.

13. An animal healthcare method comprising:
a) receiving questionnaire items according to a prevalent disease for each classified animal group;
b) receiving diagnostic information of an animal using a differential diagnosis or examination content corresponding to the questionnaire items; and
c) determining whether a disease is expressed in the animal using the diagnostic information.

14. The animal healthcare method of claim 13, further comprising
d) receiving an examination result of a health examination program determined according to the disease, wherein, in the step c), it is determined whether the disease is expressed using the diagnostic information and the examination result.

15. The animal healthcare method of claim 13, further comprising
e) transmitting a health examination program determined according to the disease to a caregiver terminal of the animal.

16. The animal healthcare method of claim 13,
wherein the classified animal group is a group obtained by classifying animals by breeds and age ranges,
wherein the questionnaire items are questionnaire items related to a disease that occurs at a frequency above a reference frequency for each group, and
wherein the prevalent disease includes at least one of a cardiac disease, an oral disease, a skin disease, an endocrinological/metabolic disease, a gastrointestinal disease, a blood disease, a musculoskeletal disease, a tumor, a neurological disease, an ophthalmic disease, a respiratory disease, a genitourinary disease, and a drug-susceptible disease.

17. The animal healthcare method of claim 14, further comprising:
f) classifying determined biosignal information of the animal into a normal group or a disease-specific group according to a determination result of whether the disease is expressed;
g) receiving daily biosignal information of the animal; and
h) comparing the daily biosignal information with biosignal information for each group, and determining whether a disease corresponding to the biosignal information for each group is expressed using the comparison result.

18. The animal healthcare method of claim 17, further comprising:
i) transmitting disease information determined using the comparison result to a caregiver terminal of the animal, and transmitting the disease information and the examination result to an electronic medical record (EMR) system of an animal hospital in which the animal is registered.

19. The animal healthcare method of claim 18,
wherein step h), a pattern of average data of the daily biosignal information of the animal is compared with a pattern of average data of the biosignal information for each group, a degree of similarity between the two patterns is determined, and it is determined whether a disease corresponding to the biosignal information for each group is expressed according to the determination result.

20. The animal healthcare method of claim 19, wherein the step h) comprises:
(h1) calculating average data including an average value, a median value, a standard deviation, and a change rate of the biosignal information for each classified group; and
(h2) comparing at least one of the average data calculated in the step (h1) with the average data of the daily biosignal information of the animal,
wherein the pattern of average data of biosignal information for each group is a pattern of average data corresponding to the disease-specific group when a ratio between average data corresponding to the normal group and the average data corresponding to the disease-specific group is outside of a predetermined ratio.
